(19) United States
(12) Patent Application Publication
(10) Pub. No.: US 2012/0278108 A1
(43) Pub. Date: Nov. 1, 2012

(54) SYSTEMS AND METHODS FOR IMPROVING ACCURACY OF INSURANCE QUOTES

(75) Inventors: Michael Gaughan, Elmhurst, IL (US); Clifton Burns, Geneva, IL (US)

(73) Assignee: TRANS UNION LLC., Chicago, IL (US)

(21) Appl. No.: 13/223,154

(22) Filed: Aug. 31, 2011

Related U.S. Application Data
(60) Provisional application No. 61/378,851, filed on Aug. 31, 2010.

(51) Int. Cl. G06Q 40/08

(52) U.S. Cl. 705/4

(57) ABSTRACT

A method for improving the accuracy of a quote generated by an insurance business to a consumer for an insurance product is provided. The method determines personal identifying data of the consumer, matches the determined identifying data with one of the personal identifiers listed in an index file. The method identifies a plurality of insurance claims associated with the matched personal identifier, determines which of the identified insurance claims are chargeable based on a claim criteria provided by the insurance business, and returns a claim score to the insurance business indicative of a number of claims determined to be chargeable. The method further identifies a plurality of personal injury insurance claims associated with the matched personal identifier, determines which of the identified personal injury insurance claims are pertinent based on claim criteria provided by the insurance business, and returns an alert to the insurance business identifying pertinent personal injury claims.

### CROSS REFERENCE TO RELATED APPLICATION

This application is a non-provisional of U.S. patent application No. 61/378,851 filed on Aug. 31, 2010, which is incorporated herein by reference in its entirety.

### TECHNICAL FIELD

This invention generally relates to the insurance industry, and more particularly to systems and methods for improving accuracy of quotes for an insurance product, such as a vehicle insurance product.

### BACKGROUND OF THE INVENTION

Insurance application volume is increasing—driven by price competition among insurance carriers, increased advertising, and, economic conditions that prompt more consumers to shop their automobile insurance policies when the time to renew their policies approaches.

Typically, the process to provide an accurate preliminary automobile insurance quote to a potential customer normally takes easily ten or more minutes and requires hundreds of pieces of data as input. The quoting process is iterative with a preliminary quote early in the process and one or more refined quotes provided as additional data is obtained. Conventionally, an insurance carrier orders a consumer's claim history data after the applicant has accepted the preliminary quote. The carrier may then re-quote the policy based on the consumer's auto claim history.

The quoting process is time consuming and costly. Recently, insurance carriers reported increases in quotes of twenty-five percent (25%) over the prior year. However, while quotes have increased, carriers have issued substantially the same number of policies. Many applicants seem to abandon the application process because they run out patience or become disappointed if the final insurance rate is higher than initially quoted. As a result, the success rates, from quoting to policy being issued, have decreased from about eight to one (8:1) to about fifteen to one (15:1). One explanation of this decrease in the quote-to-issue rates is that the best policyholders seem to shop for the best possible policy rates, which leads insurance carriers to be concerned that they might lose some of their best risks.

Policy premiums or rates, determined by insurance carriers, should accurately reflect the risks insured against, so that they can offer competitively priced yet profitable policies. Thus, accurate premium determination, based on proper risk evaluation, is critical for such carriers. The premium accuracy depends upon the accuracy of the data forming the basis for the evaluation, which typically is based on driving records, credit records, and name and address records, acquired from independent sources. Another critical factor to be evaluated as part of the risk assessment is whether an applicant has had previous personal injury claims and payouts for these claims over certain amounts.

Therefore, there is a need for an improved insurance quoting system and method that can render the quoting process more accurate and more efficient, thereby increasing customer satisfaction and enhancing profitability for insurance carriers by greatly reducing the time and resources required to make a quote and improving the quote-to-issue ratio.

### SUMMARY OF THE INVENTION

The present invention is defined by the appended claims. This description summarizes some aspects of the present embodiments and should not be used to limit the claims.

The present invention is intended to solve the above-noted business and technical problems by providing systems and methods for improving the accuracy of a quote generated by an insurance business to a consumer for an insurance product. The method determines personal identifying data of the consumer, matches the determined personal identifying data with one of the personal identifiers listed in an index file. The method determines a plurality of insurance claims associated with the matched personal identifier, determines which of the determined insurance claims are chargeable based on a claim criteria provided by the insurance business, and returns a claim score to the insurance business indicative of a number of claims determined to be chargeable. Another method further notifies the insurance carrier of the presence of previous personal injury protection (PIP) claims with selected criteria associated with the matched personal identifier, such as the number of PIP claims within a specified time period or the number of PIP claims with certain payout amounts.

In another aspect of the invention, a non-transitory computer-readable medium comprising computer-readable instructions for improving the accuracy of a quote generated by an insurance business to a consumer for an insurance product is provided. The non-transitory computer-readable instructions, when executed by a computer, cause the computer to perform the method steps discussed above.

### BRIEF DESCRIPTION OF THE DRAWINGS

For a better understanding of the invention, reference may be had to preferred embodiments shown in the following drawings in which:

FIG. 1 is a block diagram of one form of a computer or server of FIG. 2, having a memory element with a computer readable medium for implementing the computing system used for collecting and processing consumer information in accordance with the present invention;

FIG. 2 is a block diagram illustrating a networked computing system for collecting and processing credit and claim information associated with consumers seeking insurance quotes in accordance with a particular embodiment of the present invention;

FIG. 3 is a diagram illustrating differences between credit and claim database inquiries in response to carrier inquiries made to generate policy quotes for consumers;

FIG. 4 is a diagram illustrating a process for generating a file indexing claims to credit records in accordance with the present invention;

FIG. 6 is a diagram illustrating an improvement in the accuracy of identifying valid claims in accordance with the present invention;

FIG. 6 is a flow chart illustrating a method for generating consumer scores based on processed consumer credit and claim information and an index file in accordance with the present invention; and

FIG. 7 is a flow chart illustrating a method for generating notifications of prior PIP claims based on selected carrier criteria in accordance with the present invention.

### DETAILED DESCRIPTION OF PREFERRED EMBODIMENTS

The present invention is defined by the appended claims. This description summarizes some aspects of the present embodiments and should not be used to limit the claims.

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

In accordance with principles of the invention, systems and methods are provided for selecting insurance claims associated with consumers and determining which of the claims are valid based on the consumers' credit histories and meet the insurance company's risk criteria for assessing premium surcharges for insurance policies sought by the consumers, thereby greatly reducing the time and resources required to make a quote and improving the accuracy of the rates or premiums of premiums offered to the consumers.

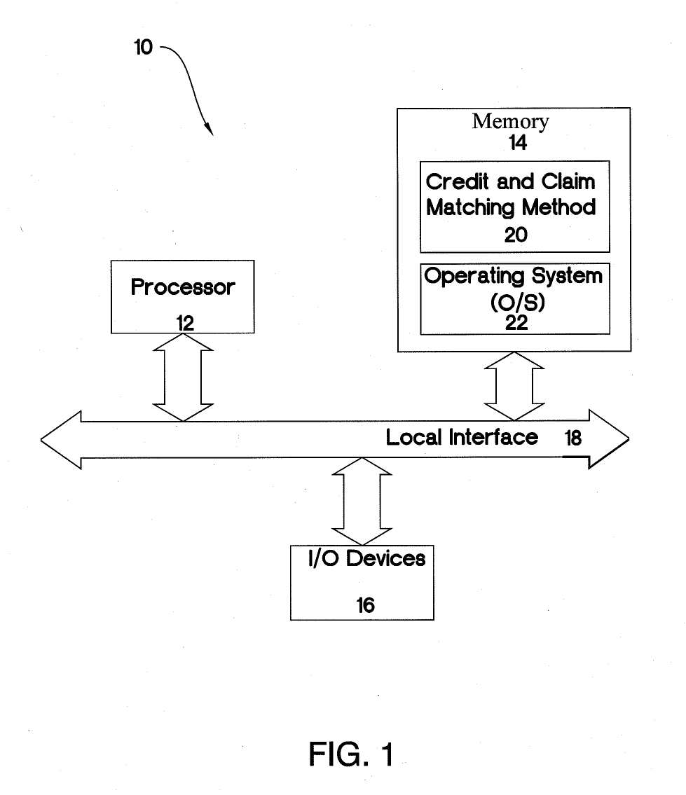

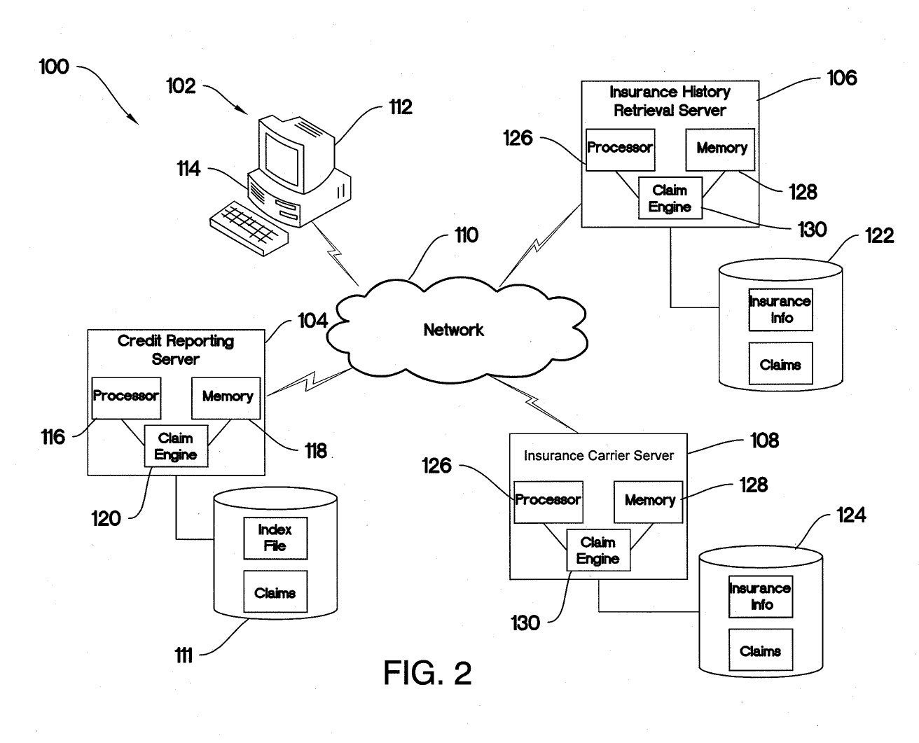

FIG. 1 is a block diagram of a computer 10. The computer 10 may be any one of the user computer 102, the credit server 104, the insurance history retrieval server 106 or the insurance carrier server 108 of FIG. 2, or any computer associated with the networked system 100. Without loss of generality and as an exemplary computer, the credit sever 104 is discussed hereafter. The computer 10 may include a memory 14. The memory 14 may include a computer readable medium for implementing the method 20 for improving accuracy of insurance quotes.

The method 20 may be implemented in software, firmware, hardware, or any combination thereof. For example, in one mode, the method 20 is implemented in software, as an executable program, and is executed by one or more special or general purpose digital computer(s), such as a personal computer (PC; IBM-compatible, Apple-compatible, or otherwise), personal digital assistant, workstation, minicomputer, mainframe computer, computer network, “virtual network” or “internet cloud computing facility”. Therefore, computer 10 may be representative of any computer in which the method 20 resides or partially resides.

Generally, in terms of hardware architecture, as shown in FIG. 1, the computer 10 includes a processor 12, memory 14, and one or more input and/or output (I/O) devices 16 (or peripherals) that are communicatively coupled via a local interface 18. The local interface 18 may be, for example, but is not limited to, one or more buses or other wired or wireless connections, as is known in the art. The local interface 18 may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor 12 is a hardware device for executing software, particularly software stored in memory 14. Processor 12 can be any custom made or commercially available processor, a central processing unit (CPU), an auxiliary processor among several processors associated with the computer 10, a semiconductor based microprocessor (in the form of a microchip or chip set), another type of microprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. Processor 12 may also represent a distributed processing architecture such as, but not limited to, SQL, Smalltalk, APL, KLisp, Snobol, Developer 200, MUMPS/Magic.

Memory 14 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 14 may incorporate electronic, magnetic, optical, and/or other types of storage media. Memory 14 can have a distributed architecture where various components are situated remote from one another, but are still accessed by processor 12.

The software in memory 14 may include one or more separate programs. The separate programs comprise ordered listings of executable instructions for implementing logical functions. In the example of FIG. 1, the software in memory 14 includes the method 20 in accordance with the present invention, a suitable operating system (O/S) 22. A non-exhaustive list of examples of suitable commercially available operating systems 22 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system 22 essentially controls the execution of other computer programs, such as the method 20, and provides scheduling, input-output control, file and data management, memory management, and communication control and related services.

The method 20 may be a source program, executable program (object code), script, or any other entity comprising a set of instructions to be performed. When a “source” program, the program needs to be translated via a compiler, assembler, interpreter, or the like, which may or may not be included within the memory 14, so as to operate properly in connection with the operating system 22. Furthermore, the operating system 22 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, .Net, HTML, and Ada. In one embodiment, the platform system 22 is written in Java.

The I/O devices 16 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices 16 may also include output devices, for example but not limited to, output modules for PLCs, a printer, bar code printers, displays, etc. Finally, the I/O devices 16 may further comprise devices that communicate with both inputs and outputs, including, but not limited to, a modulator/demodulator (modem; for accessing another device, system, or network), a radio frequency (RF) or other transceiver, a telephonic interface, a bridge, and a router.

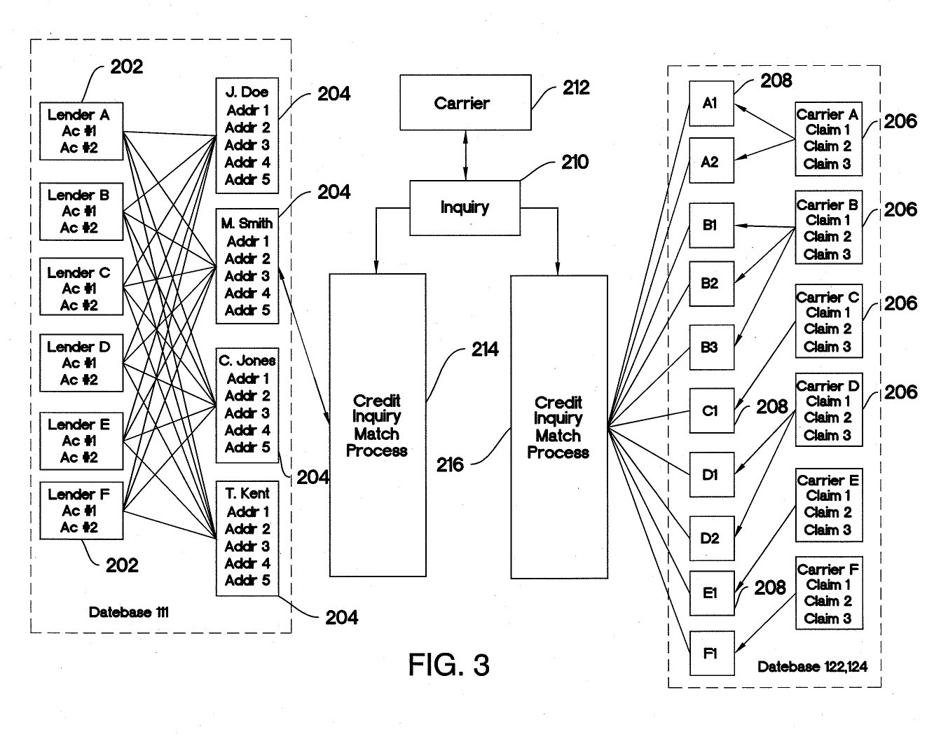

If the computer 10 is a PC, workstation, PDA, or the like, the software in the memory 14 may further include a basic input output system (BIOS) (not shown in FIG. 3). The BIOS is a set of essential software routines that initialize and test hardware at startup, start the operating system 22, and support the transfer of data among the hardware devices. The BIOS is stored in ROM so that the BIOS can be executed when computer 10 is activated.

When computer 10 is in operation, processor 12 is configured to execute software stored within memory 14, to communicate data to and from memory 14, and to generally control operations of computer 10 pursuant to the software. The method 20, and the operating system 22, in whole or in part, but typically the latter, may be read by processor 12, buffered within the processor 12, and then executed.

When the method 20 is implemented in software, as is shown in FIG. 1, it should be noted that the method 20 can be stored on any computer readable medium for use by or in connection with any computer related system or method, although in one preferred embodiment, the method 20 is implemented in a centralized application service provider arrangement. In the context of this document, a computer readable medium is an electronic, magnetic, optical, or other physical device or means that can contain or store a computer program for use by or in connection with a computer related system or method. The method 20 can be embodied in any type of computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the method 20 is implemented in hardware, the method 20 may also be implemented with any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Now referring to FIG. 2, a networked system 100 for collecting and processing credit and claim information associated with consumers seeking insurance quotes is shown in accordance with a particular embodiment of the invention. In the embodiment of FIG. 2, the networked system 100 comprises a user computer 102 and a server 104, both communicatively connected to at least one insurance history retrieval server 106 and at least one insurance carrier server 108 through a network 110 (e.g. the Internet). The user computer 102 may include a computer monitor 112 and a desktop processing unit 114. The server 104 may include a processor unit 116, a memory unit 118 and a credit engine unit 120. Each of the insurance history retrieval server 106 and insurance carrier server 108 is coupled to insurance databases 122 and 124, respectively, and may also include a processor unit 126, a memory unit 128 and a claim engine 130. The user computer 102 and the server 104 may be connected through a local area network (LAN). Alternatively, the user computer 102 and the server 104 may be communicatively coupled to one another via a global network or a wide area network (WAN). Further, the user computer 102, which is shown as a personal computer, may be a handheld or a portable computing device. The server 104 preferably includes a plurality of programs, including but not limited to programs stored within the memory unit 118 for receiving and processing queries transmitted from the user computer 102 electronically. Similarly, each of the insurance history retrieval server 106 and insurance carrier server 108 preferably includes a plurality of programs, including but not limited to programs stored within memory units 128 for receiving and processing queries transmitted from the user computer 102 and the server 104 electronically. In certain preferred embodiments, the electronic transmission between the insurance history retrieval server 106 and the insurance carrier server 108 and either the user computer 102 or the server 104 may occur through File Transfer Protocol (“FTP”) or Internet Transfer Protocol (“TCP/IP”) or others.

In one embodiment, the server 104 is associated with a credit reporting business, and the credit database 111 is configured to maintain credit information on consumers and claim information received from databases 124. The credit information is structured to include a substantially accurate and complete credit history of consumers, with a high confidence level that all loans/records belong to the appropriate consumers. The credit engine unit 120 is operative to receive credit report data relating to a consumer or other entity and process the data against a proprietary or other credit scoring model to yield a credit score. Suitable credit scoring models include TransRisk® by TransUnion, LLC. When determining a potential policy rate or premium, the yielded credit score is an informative and immediately usable piece of data at the beginning of the insurance quoting process. The credit database 111 is configured to be individual centric, by saving all name, address, social security number (SSN) and date of birth (DOB) combinations of the consumer. As such, a search or selection process of an individual or consumer is configured to support traditional changes in the consumer's lifecycle, e.g. new address or new name (marriage/divorce), to compensate for data entry errors, e.g. typos, transpositions, and the like. As shown in FIG. 3 the credit database 111 is structured to associate a plurality of loan lender files 202 with a plurality of consumer accounts. A particular aspect of credit database updates is to build and maintain complete consumer files 204 as data updates are received which are returned in response to inquiries.

In one embodiment, the server 104 is associated with an insurance loss history information retrieval business, and the insurance history retrieval server 106 is associated with an insurance carrier. Their respective databases 122, 124 are configured to maintain insurance loss histories and other behavior information for individual consumers. The insurance loss histories are typically captured in the form of claims filed by consumers. Due to the lack of precise personal identifying data maintained by the insurance carriers and insurance history retrieval businesses in these databases 122, 124, claims are not always matched to the same consumers because they have changed names (due to marriage or divorce for example), have changed addresses or because of data entry errors. Moreover, personal identifying data is not always updated after a claim is closed. As shown in FIG. 3, each of the claim databases 122, 124 is structured to associate a plurality of carriers A-F 206 with a plurality of individual claims. A particular aspect of the claim database updates is to build and maintain complete claim files 208 and creates household reports while the inquiries are processed.

As illustrated in FIG. 3, an inquiry 210 instigated by a carrier 212 can spawn a credit inquiry match process 214 and a claim inquiry match process 216. The credit inquiry match process 214 attempts to match current identity data to identity data reported with current account updates. The claim inquiry match process 216 attempts to match current identity data to identity data reported at the time of the claim. As such, an existing individual credit report is selected from the complete consumer files 204 by the credit inquiry match process 214, while a household claim report is assembled “on-the-fly” from the claim files 208 by the claim inquiry match process 216.

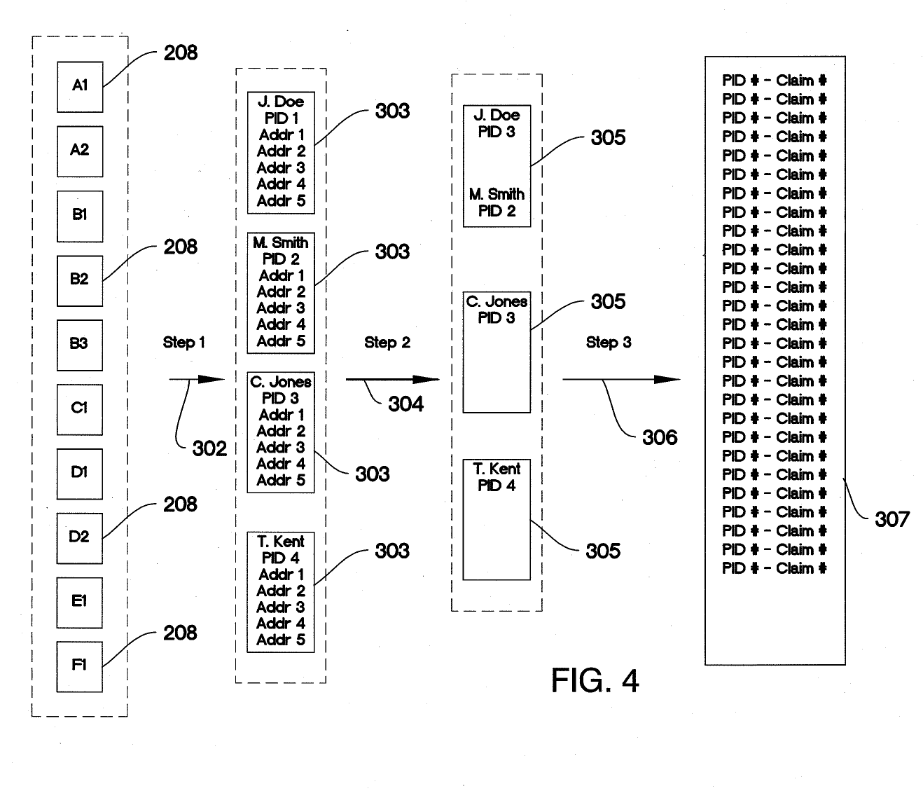

Now referring to FIG. 4, an embodiment of a process for generating a file indexing claims to credit records in accordance with the invention is shown. In a first step 302, claim files 208 of consumers, maintained in one of claim databases 124, are matched to historical identity data of the consumer, maintained in the credit database 111, which enables the linking of claim reference numbers to a permanent identifier (PID) associated with the consumer, to create individual credit files 303. Each of the created individual credit files 303 includes the consumer's PID and at least a set of addresses historically associated with the consumer. As shown in a second step 304, consumer records are “householded” or “de-duplicated” using current identification data maintained in the credit database 111. The process of householding or de-duplicating involves matching a set of claims to a plurality of consumers associated with the same household, thereby associating the set of claims to the consumers' household. As such, a set of household files 305, each including at least one of the individual credit files 303, is created. As shown in FIG. 4, a consumer named J. Doe and identified with PID 1 is made to share the same household file 305 with another consumer named M. Smith identified with PID 2. In a third step 306, individual records are created by matching each consumer's PID to the claims associated with them. The PID is configured to maintain a link between the consumer's credit file and the associated claims even as addresses and names change over time. As such, an index file 307 associating PIDs to matched claims is generated. The generated index file 307 can be updated periodically, such as weekly for example or as frequently as desired, by driving periodic claim updates and database householdings. Because a PID is associated with current and accurate individual credit data, false positive claim returns are not part of the matched claims. The false positive claims are rejected during the matching process because they are found to lack important identifying data associated in the individual PID and/or that they are already associated with multiple consumers associated with the same household. A traditional claim search, generated by an insurance carrier or an insurance loss history information retrieval business in response to a claim inquiry, may include false positive claims that are not returned by the claim inquiry process utilizing PIDs, and may not include a set of valid claims discovered by PID process. A comparison 400 between the two claim searches in a particular example, illustrated in FIG. 5, shows that while a traditional claim search generated a hit rate of 53%, of which the false positive hit rate amounted to about 6.5%. Whereas, a PID claim search, of the same claim database, generated a hit rate of 54.1%, including a 7.6% hit rate of claims not previously found by the traditional claim search. The additional 7.6% hit rate of valid claims may translate into more chargeable claims during the insurance quoting process.

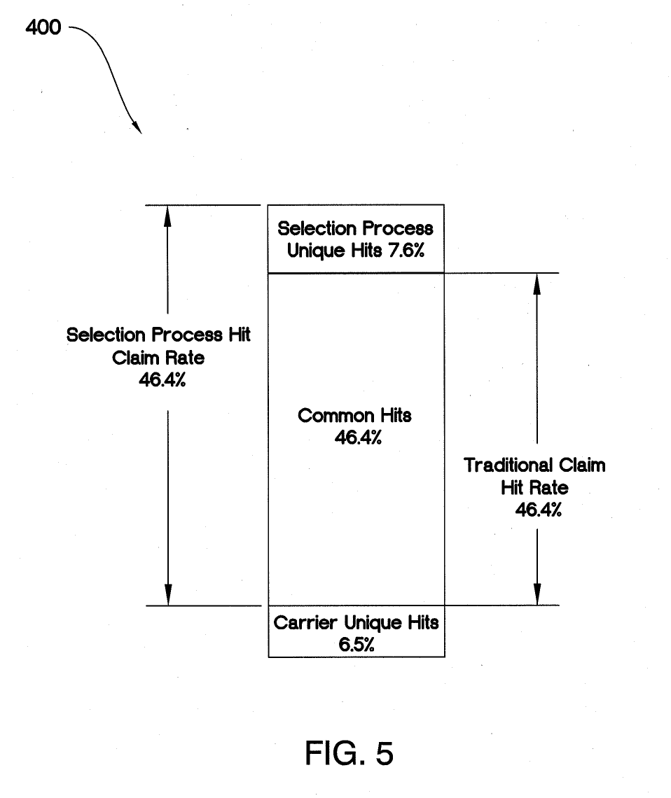

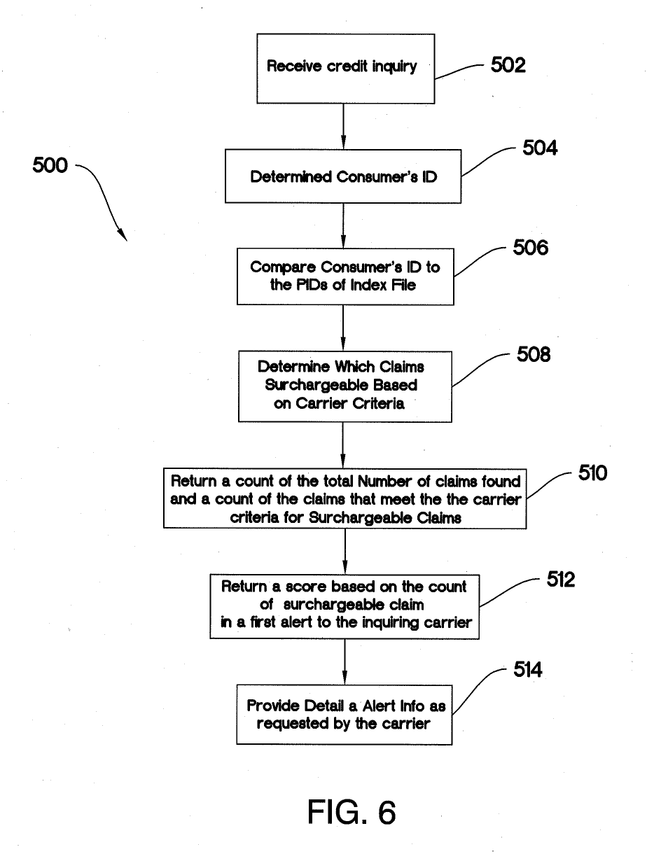

Now referring to FIG. 6, a flow chart illustrates an embodiment 500 of a method for generating consumer insurance scores based on processed consumer credit and claim information and an index file in accordance with the present invention. At Step 502, a credit inquiry is received for a particular consumer from a program residing in or associated with the credit server 104, the program then making an insurance claim inquiry for the consumer from a program associated with or residing in either the insurance history retrieval server 106 or the insurance carrier server 108. A determination is then made as to the consumer's ID, using the subject selection process discussed above, at Step 504. At Step 506, the consumer's ID is compared to PIDs listed in the Index file, to identify associated claims. At Step 508, the identified claims are filtered using the insurance carrier criteria established to determine which ones of these claims are surchargeable. The identified claims can be filtered based on, for example:

State

Date of Loss

Coverage Type

Settlement Amount

Claim Status

Role in Claim

At Step 510, a first count of the total number of identified claims by the filtering process and a second count of the surchargeable identified claims that meet the carrier criteria may be returned to the inquiring program. Moreover, at Step 512, a score indicative of the surchargeable claims may be returned as a first alert data to the inquiring carrier, which as stated above can be helpful in determining a potential insurance quote early in the quoting process. In the event that the inquiring carrier desires a more detailed full claim history report, then a full claim report may be returned with the filtering results identified and tagged for each claim, at Step 514.

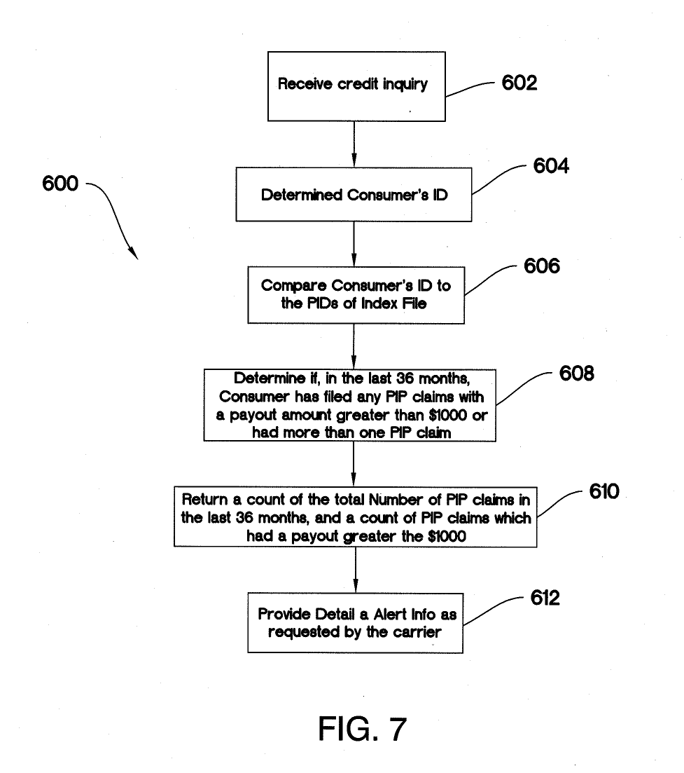

Now referring to FIG. 7, a flow chart illustrates an embodiment 600 of a method for notifying a carrier of prior personal injury protection (PIP) claims filed by a consumer based on processed consumer claim information and an index file in accordance with the present invention. At Step 602, a credit inquiry is received for a particular consumer from a program residing in or associated with the credit server 104, the program then making an insurance claim inquiry for the consumer from a program associated with or residing in either the insurance history retrieval server 106 or the insurance carrier server 108. A determination is then made as to the consumer's ID, using the subject selection process discussed above, at Step 604. At Step 606, the consumer's ID is compared to PIDs listed in the Index file, to identify associated PIP claims. At Step 608, any previous PIP claims filed by the consumer are filtered by the carrier's criteria to determine if the consumer's past history regarding PIP claims is pertinent to the inquiring carrier. The identified PIP claims can be filtered based on, for example, date of claim or payout amount of claim. For example, as shown in Step 608, any PIP claims filed by the consumer in the last 36 months with a payout greater than $1000 may be filtered, and/or if the consumer has filed more than one PIP claim in the last 36 months. Of course, any desired criteria may be selected by the carrier. In the embodiment in 600, for example, any time period or payout amount may be used as the criteria for identifying past pertinent PIP claims. At Step 610, a first count of the total number of identified PIP claims by the filtering process and a second count of the identified claims that meet the carrier criteria may be returned to the inquiring program. Moreover, at Step 612, an alert identifying pertinent PIP claims may be returned to the inquiring carrier, which as stated above can be helpful in determining a potential insurance quote early in the quoting process.

The method in 600 can be a stand-alone method of identifying desired past PIP claims, but it is also contemplated that the method of 600 can be combined with the method in 500, such that both processes are executed simultaneously to provide alerts as described above for each method. Both methods 500 and 600 are based on processed consumer credit and claim information and an index file in accordance with the present invention, and as such both processes can be executed simultaneously. In such an embodiment (not shown), both an alert relating to credit score according to method 500 and an alert relating to pertinent PIP claims according to method 600 are returned to the carrier, thereby providing first and second alerts with both types of information.

Accordingly, the disclosed method improves the accuracy of claim searches by finding more claims and eliminating false positive claims. The filtering option helps to identify chargeable claims. As a result, application quoting time is reduced because if the quote, determined by the returned claim score, is competitive, the consumer becomes a new insurance buyer. Moreover, if the quote is not competitive the time spent with potential non-buyers may be reduced. As such, the close ratio is improved, as well as the experience of the consumer and the carrier agent.

Although exemplary embodiments of the invention have been described in detail above, those skilled in the art will readily appreciate that many additional modifications are possible in the exemplary embodiment without materially departing from the novel teachings and advantages of the invention. Accordingly, these and all such modifications are intended to be included within the scope of this invention.

We claim:

1. A method for improving the accuracy of a quote generated by an insurance business to a consumer for an insurance product, the method performed by one or more processors comprising:
determining personal identifying data of the consumer;
matching the determined personal identifying data with one of a plurality of personal identifiers listed in an index file stored on a memory;
identifying a plurality of insurance claims associated with the matched personal identifier;
determining which of the identified insurance claims are chargeable based on a claim criteria provided by the insurance business; and
returning a claim score to the insurance business indicative of a number of claims determined to be chargeable.

2. The method of claim 1, wherein the index file comprises a plurality of consumer records, each of the consumer records matches a consumer personal identifier to associated insurance claims.

3. The method of claim 2, wherein the each of the plurality of consumer records are generated by matching claims records to historical identity data of consumers and linking claim reference numbers to personal identifiers of the consumers.

4. The method of claim 3, wherein the generated consumer records are householded to remove duplication of claims associated with consumers belonging to the same household.

5. The method of claim 1, wherein the insurance business is an insurance carrier.

6. The method of claim 1, wherein the insurance business is an insurance loss history information retrieval business.

7. A method for improving the accuracy of a quote generated by an insurance business to a consumer for an insurance product, the method performed by one or more processors comprising;
determining personal identifying data of the consumer;
matching the determined personal identifying data with one of a plurality of personal identifiers listed in an index file stored on a memory;
identifying a plurality of personal injury insurance claims associated with the matched personal identifier;
determining which of the identified personal injury insurance claims are pertinent based on claim criteria provided by the insurance business; and
returning an alert to the insurance business identifying pertinent personal injury claims.

8. The method of claim 7, wherein the index file comprises a plurality of consumer records, each of the consumer records matches a consumer personal identifier to associated insurance claims.

9. The method of claim 8, wherein the each of the plurality of consumer records are generated by matching claims records to historical identity data of consumers and linking claim reference numbers to personal identifiers of the consumers.

10. The method of claim 9, wherein the generated consumer records are householded to remove duplication of claims associated with consumers belonging to the same household.

11. The method of claim 7, wherein the insurance business is an insurance carrier.

12. The method of claim 7, wherein the insurance business is an insurance loss history information retrieval business.

13. The method of claim 7, wherein one claim criteria is date of a personal injury insurance claim.

14. The method of claim 7, wherein one claim criteria is payout amount of a personal injury insurance claim.

15. A computer-based system for improving the accuracy of a quote generated by an insurance business to a consumer for an insurance product, the system comprising:
a computer having at least one processor;
a computer memory accessible by the at least one processor for executing code instructions stored in the computer memory, the code instructions comprising:
a first code segment enabling the at least one processor to determine personal identifying data of the consumer;
a second code segment enabling the at least one processor to match the determined personal identifying data with one of a plurality of personal identifiers listed in an index file stored on a memory;
a third code segment enabling the at least one processor to identify a plurality of insurance claims associated with the matched personal identifier;
a fourth code segment enabling the at least one processor to determine which of the identified insurance claims are chargeable based on a claim criteria provided by the insurance business; and
a fifth code segment enabling the at least one processor to return a claim score to the insurance business indicative of a number of claims determined to be chargeable.

16. The computer-based system of claim 15, wherein the index file comprises a plurality of consumer records, each of the consumer records matches a consumer personal identifier to associated insurance claims.

17. The computer-based system of claim 16, wherein the each of the plurality of consumer records are generated by matching claims records to historical identity data of consumers and linking claim reference numbers to personal identifiers of the consumers.

18. The computer-based system of claim 17, wherein the generated consumer records are householded to remove duplication of claims associated with consumers belonging to the same household.

19. The computer-based system of claim 15, wherein the insurance business is an insurance carrier.

20. The computer-based system of claim 15, wherein the insurance business is an insurance loss history information retrieval business.

21. A non-transitory computer-readable medium encoded with instructions for improving the accuracy of a quote generated by an insurance business to a consumer for an insurance product, the encoded instructions comprising:
a first code segment enabling a computer to determine personal identifying data of the consumer;
a second code segment enabling the computer to match the determined personal identifying data with one of a plurality of personal identifiers listed in an index file stored on a memory;
a third code segment enabling the computer to identify a plurality of personal injury insurance claims associated with the matched personal identifier;
a fourth code segment enabling the computer to determine which of the identified personal injury insurance claims are pertinent based on claim criteria provided by the insurance business; and
a fifth code segment enabling the computer to return an alert to the insurance business identifying pertinent personal injury claims.

22. The computer-readable medium of claim 21, wherein the index file comprises a plurality of consumer records, each of the consumer records matches a consumer personal identifier to associated insurance claims.

23. The computer-readable medium of claim 22, wherein the each of the plurality of consumer records are generated by matching claims records to historical identity data of consumers and linking claim reference numbers to personal identifiers of the consumers.

24. The computer-readable medium of claim 23, wherein the generated consumer records are householded to remove duplication of claims associated with consumers belonging to the same household.

25. The computer-readable medium of claim 21, wherein the insurance business is an insurance carrier.

26. The computer-readable medium of claim 21, wherein the insurance business is an insurance loss history information retrieval business.

27. The computer-readable medium of claim 21 wherein one claim criteria is date of a personal injury insurance claim.

28. The computer-readable medium of claim 21, wherein one claim criteria is payout amount of a personal injury insurance claim.

29. A method for improving the accuracy of a quote generated by an insurance business to a consumer for an insurance product, the method performed by one or more processors comprising;
determining personal identifying data of the consumer;
matching the determined personal identifying data with one of a plurality of personal identifiers listed in an index file stored on a memory;
identifying a plurality of insurance claims associated with the matched personal identifier;
determining which of the identified insurance claims are chargeable based on a claim criteria provided by the insurance business;
returning a first alert to the insurance business indicative of a number of claims determined to be chargeable;
identifying a plurality of personal injury insurance claims associated with the matched personal identifier;
determining which of the identified personal injury insurance claims are pertinent based on claim criteria provided by the insurance business; and
returning a second alert to the insurance business identifying pertinent personal injury claims.
